(19) United States
(12) Patent Application Publication
(10) Pub. No.: US 2006/0179033 A1
(43) Pub. Date: Aug. 10, 2006

(54) Method and system for digital asset management

(76) Inventors: Oliver Stanke, Saarbruecken (DE); Arno Meyer, Saarbruecken (DE); Frank Speidel, Pleidelsheim (DE); Roland Schlosser, Ottweiler (DE)

Correspondence Address: KENYON & KENYON, 1500 K STREET N.W., WASHINGTON, DC, 20005, US

(21) Appl. No.: 11/261,791

(22) Filed: Oct. 31, 2005

Related U.S. Application Data
(60) Provisional application No. 60/650,950, filed on Feb. 9, 2005.

(51) Int. Cl. G06F 17/30

(52) U.S. Cl. 707/2

(57) ABSTRACT

The disclosure relates to a digital asset storage, search and retrieval system. Each digital asset may comprise one or more versions of the asset, properties of the asset, and conditions on its use. The system may access stored digital assets using hierarchical classifications under a taxonomy.

This application claims the benefit under 35 USC 119(e) of U.S. provisional application 60/650,950, filed Feb. 9, 2005 and fully incorporated herein by reference.

### BACKGROUND OF THE INVENTION

A “digital asset” is a data object that carries marketable information content. Thus, the term covers various multimedia files, including image files, audio files (e.g., music), audio-video files and the like. The term also may cover text files or data files, such as product reports, analyses, recommendations, etc. Digital assets may be sold among various participants in a market. The assets typically are sold in contracts that limit ways in which a purchasing party may use the digital asset.

Digital asset management systems, as their name implies, are computer systems that permit asset owners to manage their assets. As another example, a digital asset management system may permit consumer product manufacturers (who manufacture an array of products) to manage their retailers' or advertisers' use of product images throughout advertisements and other commercial notices regarding the products themselves.

In known digital asset management systems, consumers' user experiences in browsing through and retrieving digital assets is awkward and non-intuitive. Therefore, there is a need in the art for a digital asset management system that is easy to use.

### BRIEF DESCRIPTION OF THE DRAWINGS

FIG. 1 shows a data structure for a digital asset according to embodiments of the present invention;

FIG. 2 shows a system to implement embodiments of the present invention;

FIGS. 3-6 show examples of screen displays according to embodiments of the present invention;

FIG. 7 shows a process flow according to embodiments of the present invention for performing a browse search for a digital asset;

FIG. 8 shows a process flow according to embodiments of the present invention for automatic notification of changes to a digital asset;

FIG. 9 shows a structure of a digital asset according to embodiments of the present invention for use with a marketing campaign; and

FIG. 10 shows a process flow according to embodiments of the present invention for logging activity involving a digital asset.

### DETAILED DESCRIPTION

Embodiments of the present invention provide methods and systems for digital asset management that address the above-described need. Embodiments of the present invention comprise a digital asset storage, search and retrieval system. The system may access stored digital assets using a hierarchical classification system, providing for efficiency in search and retrieval. Conditions on the use of each digital asset may be included with each asset, providing needed controls. Further, a number of advantageous user-friendly features provide for ease of use.

Embodiments of the present invention may further relate to an automated method of notifying users of changes to assets of interest. Further embodiments may relate to associating digital assets with marketing campaigns to provide useful analytical data.

The digital asset management system described herein may include objects and use object-oriented methods. As is known, a software object may include data and an interface through which other objects can read, change or add to the data. Linkages may be formed between objects. Though it is typically transparent to the object-oriented programmer, in embodiments objects may be implemented at least in part as tables comprising a plurality of modifiable entries that collectively exhibit the behavior that characterizes an object and that can logically link objects. For example, digital assets or digital asset versions of the digital asset management system may be objects that may be linked with other objects, such as business objects representing products.

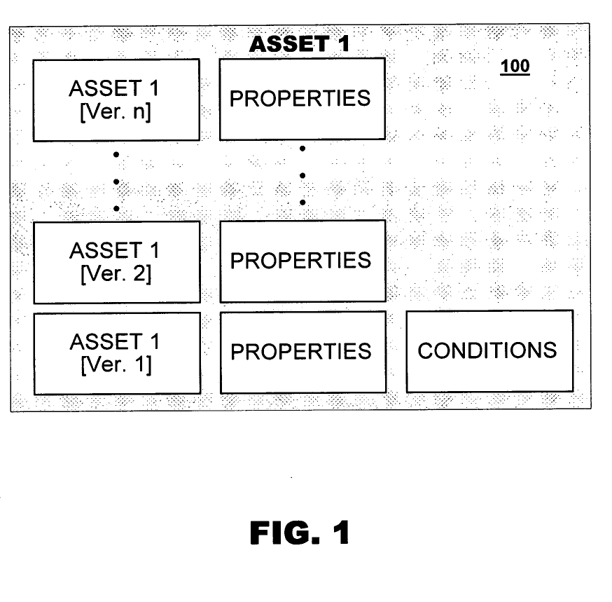

FIG. 1 shows a data structure for a digital asset 100 according to embodiments of the invention. A digital asset 100 may include multiple parts. The parts may include files of all kinds. The files may include, for example, one or more media objects, such as a picture, movie, song, data or the like. The digital asset may contain multiple versions of the files, including a latest or active version, and all previous versions.

The digital asset 100 may further include properties. The properties may be used to classify the digital asset. The properties may apply to specific versions and be different for different versions. For example, the properties may identify which of the versions of a digital asset is the effective version. Properties may also apply to the digital asset 100 as a whole and not to a specific version.

A digital asset and its versions may be viewed as a “logical information object” (LOIO) and “physical information objects” (PHIOs), respectively. A digital asset as a LOIO may be thought of as representing a general concept or category—say, “Advertisement for a diaper.” A succession of versions of the digital asset represent various actual realizations of a diaper advertisement, or PHIOs. It should be understood that, as used herein, “digital asset,” unless distinguished from a version, generally means a version of a digital asset, i.e., a PHIO.

As noted, the properties may identify which of possibly many versions is active (i.e., valid or currently in effect). Only one version can be active at a time. When a new version is added to the digital asset, it need not be identified as active. For example, it can be a work in progress not yet ready for release to other parties. When a new version is identified as active, however, a formerly active version will be designated not active. A digital asset management system may review these activeness designations within a properties field to determine which media object to release to external parties.

The digital asset 100 may further include conditions on its use. The conditions may include legal rights to and/or restrictions on use of the digital asset. The digital asset may have attributes indicating whether a condition is assigned, and whether the condition is currently valid. When an operation such as viewing or download is attempted, access control may be performed to check these attributes and determine whether the operation is valid.

The conditions may be specified, for example, as a text field, to be reviewed manually by external parties to ensure compliance with the conditions. For example, the conditions may identify a date range for which the external party is entitled to use the digital asset. The conditions could also be in the form of separate documents or files, such as .pdf or .doc files. Conditions may be inherited—propagated among related digital assets. This ensures data integrity and ensures that valid conditions are assigned to all affected digital assets.

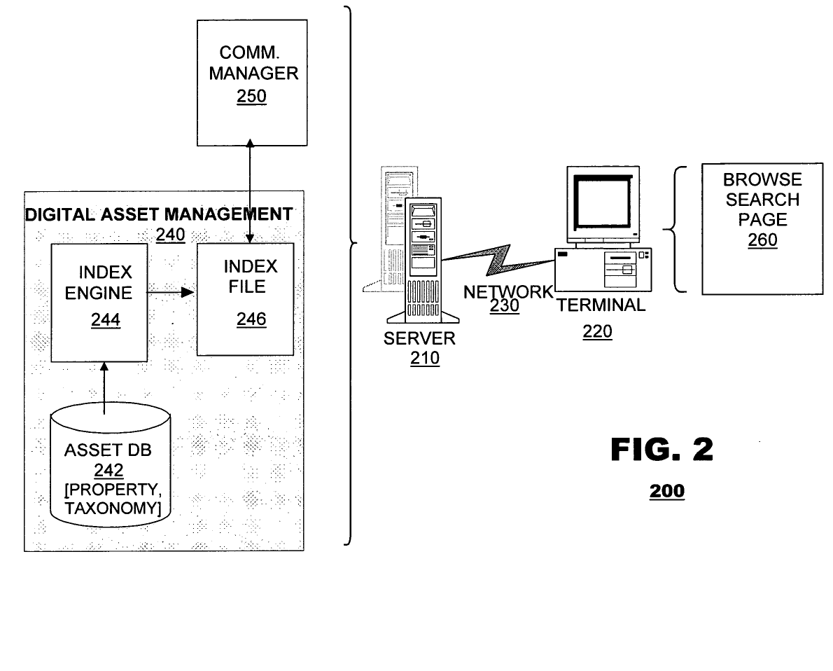

FIG. 2 illustrates a system 200 according to embodiments of the invention. The system 200 may comprise a server 210 and a terminal 220, connectable to the server 210 by a communication network 230. The network may include, for example, the Internet or World Wide Web, but could also include any wide area network (WAN) or local area network (LAN). The server 210 may include a processor and a memory coupled to the processor. The server 210 may further include storage media storing computer-executable instructions to implement a digital asset management application 240 and a communication manager 250. The server 210 may execute the digital asset management application 240 and the communication manager 250. The communication manager 250 may manage communication with the terminal 220. In particular, the communication manager may send web pages, such as a browse search page 260, interactively generated by the digital asset management application 240, via the network 230 to a client at the terminal 220.

The digital asset management application 240 may further comprise a database 242 storing digital assets. An index engine 244 of the digital asset management application 240 may access digital assets in the database 242 to form an index file 246. The index file 246 may be used, among other things, for responding to user requests by generating web pages for sending to the user. Specifically, the digital asset management application 240 may receive user requests entered by a user at a terminal 220, and execute the index engine 244 to access the asset database 242 to respond to the requests. The requests may be, in particular, search parameters entered in a browse session in order to locate a desired digital asset. Based on the search parameters entered, the user may be caused to navigate through a series of displays.

Tree structures associated with the digital assets may determine a navigation path through the displays. As is well known, a tree structure in software terms may define a hierarchy of nodes, including “root” or “parent” nodes and various levels of “child” nodes. In embodiments of the present invention, the tree structures or hierarchies may be used to implement a taxonomy or classification system under which assets are organized and classified based on their properties. The hierarchies may be built, for example, by a system administrator or other system operator who uses a GUI (graphical user interface) to define classes and related subclasses. A given asset, depending on its properties, could belong to more than one hierarchy.

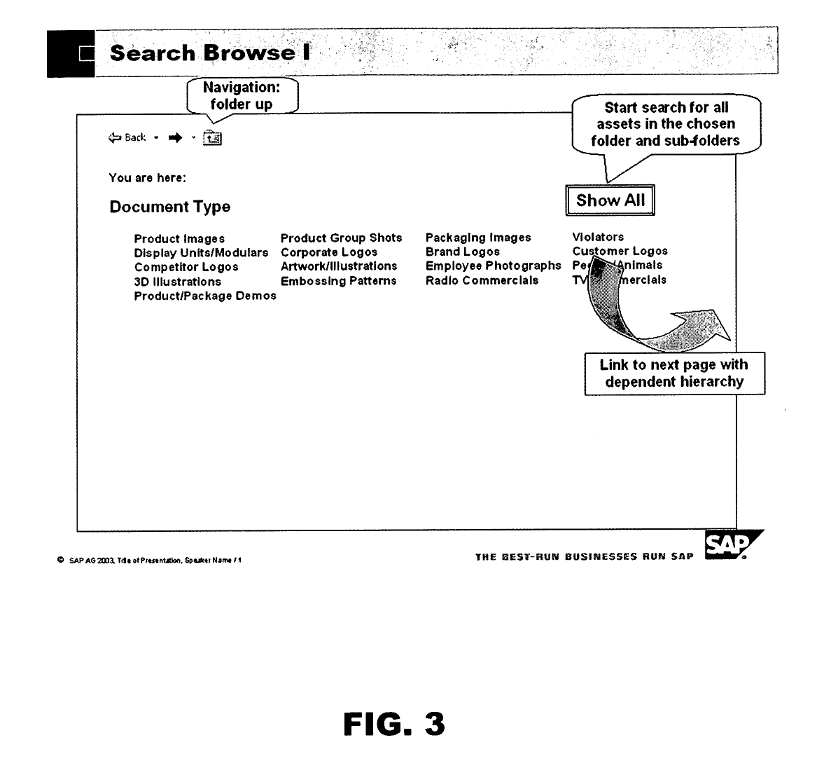

An example follows. The above-described components provide a number of capabilities and user-friendly features. Among these is a browse search capability. Browse search functionality according to embodiments of the present invention may use the hierarchical tree structures and their classifications to efficiently perform a search and present its results. FIG. 3 shows an example of a screen display that could be presented to a user, based on search parameters entered by the user. For example, a user might indicate that he wants to search for a digital asset. Possibly after one or more preceding displays (such as a log-on screen), the display of FIG. 3 may be presented to the user. The display shows a list of asset (document) types. Each list item (e.g., “Product Images” or “Customer logos”) represents a root node in a hierarchical tree structure.

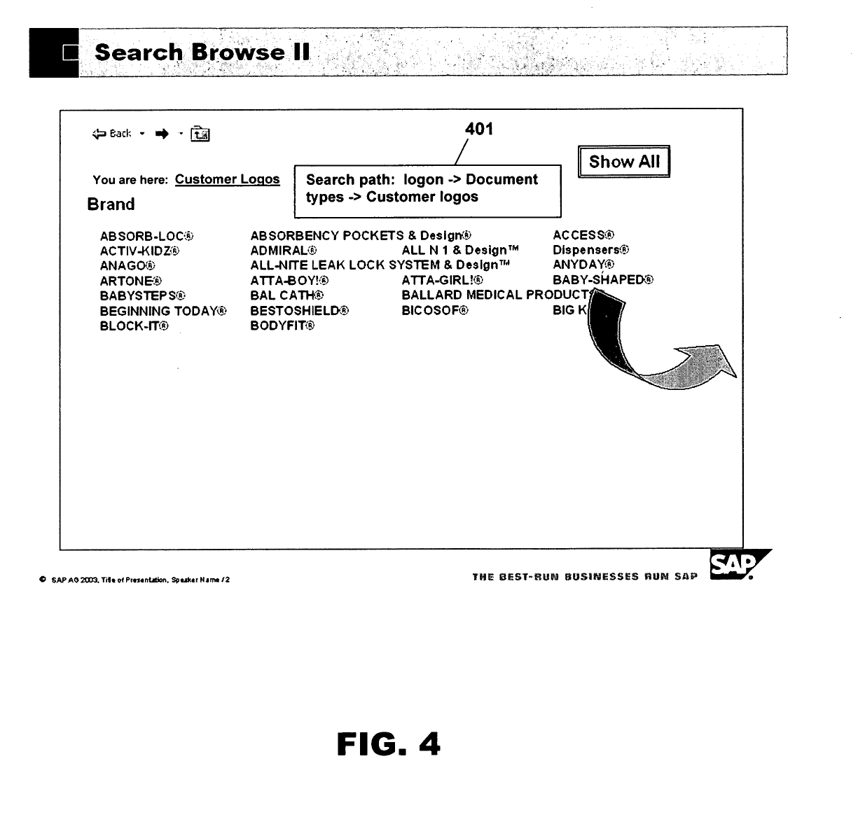

Each root node in the hierarchy may have child nodes representing a further refinement of the classification assigned to the root node. By selecting a node (e.g. by “clicking” on the corresponding field or otherwise querying or activating a node), a user may see a display of the next-lower level in the hierarchy. FIG. 4, for example, shows a display that a user might see by selecting the “Customer Logos” field and clicking on “Show All”. A list of specific customer logos is presented. Again, each specific customer logo may represent a node, classified according to a taxonomy, in a hierarchy. A user may be able to navigate upward or downward (or, backward or forward from another perspective) in the hierarchy. Moreover, a display could show more than one level of a hierarchy. For example, a display could show both child nodes and grandchild nodes of a higher-level node.

In an advantageous feature according to embodiments of the invention, a search or navigation path report 401, which indicates the path taken through a given hierarchy up to the current screen display, may be provided. The example of FIG. 4 is rather simple but it is illustrative. In actual practice navigation paths could be considerably more complex. This feature provides for a more convenient user experience because it can help the user recall how to reach a desired asset in the future, or assist the user in searching for similar assets.

When the browser is invoked, the digital asset management application 240 may determine which nodes of the hierarchy point to stored assets. “Empty” nodes, i.e., nodes to which some classification is assigned but which do not currently point to actual stored assets are not displayed. Also, nodes which contain only assets the user is not authorized to see are not displayed.

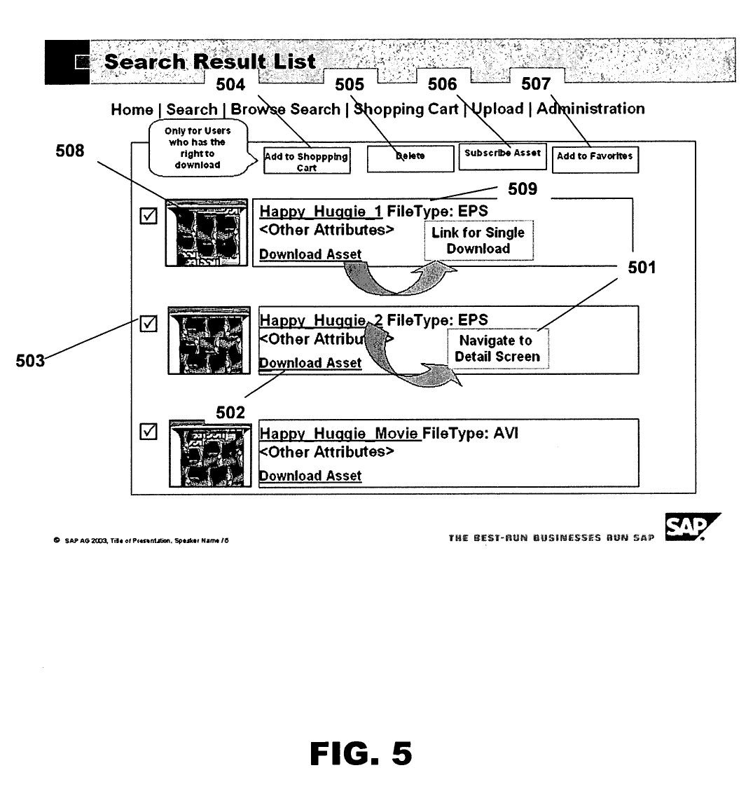

By selecting an item, say, “BABY-SHAPED®”, in the list of customer logos, a user may see the next-lower level in the hierarchy, as shown in FIG. 5. In this example, FIG. 5 represents a “results list” where nodes in the hierarchy correspond directly to stored digital assets.

As noted earlier, the same digital asset may belong to multiple different hierarchies, depending upon whether its properties fit to a given set of classifications of a hierarchy. However, the path to the digital asset may be different for each hierarchy. For example, one or more of the digital assets shown in FIG. 5 might have also been reached if the user had selected “Product Images” instead of “Customer Logos” as the root node. However, the path may have included a different series of nodes and corresponding displays, because of the way the nodes of the “Product Images” hierarchy were classified when this hierarchy was built. Thus, according to embodiments of the present invention, among other properties of a digital asset there may be a plurality of “path” properties. Each path property may identify all the levels of a given hierarchy that must be navigated in order to reach a results list.

Returning now to FIG. 5, a number of operations may be possible with a results list. For example, a user may be able to navigate to a detail view of a listed asset by clicking on a field such as box 501, download an asset on the list by clicking a field such as box 502, mark assets via a checkbox 503, add an asset or assets to a “shopping cart” (box 504), delete an asset (box 505), subscribe to an asset (box 506) (a subscriber may receive notification, via email e.g., when an asset changes) or add an asset to a “favorites” list (box 507). An asset may include a thumbnail picture 508 and a property, such as a file type 509.

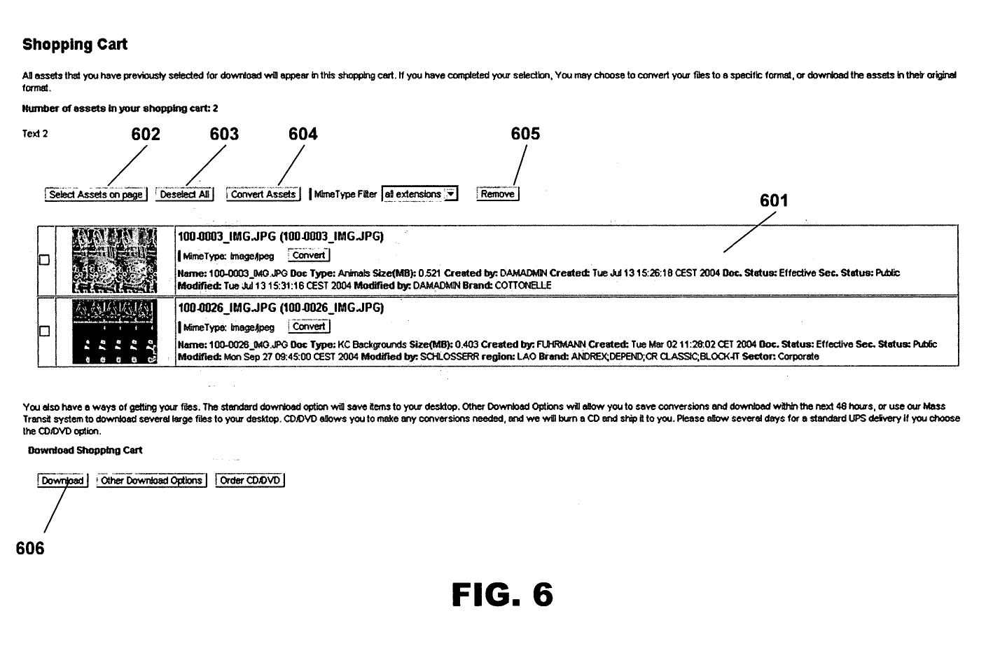

FIG. 6 shows an example of a shopping cart. A shopping cart in this context is a data container for selected assets. Shopping cart entries may include an asset report 601 that comprises such information about an asset as a file name and type, a creator of the asset and a create time, a version status (e.g. latest or acitve), a security status (e.g., access to the asset is public), a last-modified time, an identifier of the modifier, and the like.

Options further provided from the shopping cart may include selecting or de-selecting assets (boxes 602 and 603), converting an asset to a different file type (box 604), removing an asset from the shopping cart (box 605), and downloading selected assets (box 606). When an asset is downloaded, the asset report 601 may be downloaded along with the asset. The asset report 601 may further include hyperlinks (not shown) to downloaded assets. Additionally, the asset report is fully customizable via XSLT Style Sheets.

The above-described system may provide for mass upload/download of assets, or for upload/download of a single asset.

In another feature, a user can opt to assign a new filename to an exported asset. In typical scenarios, the user would select a product name or a document type as the new filename. The renaming capabilities may be based on the properties of the asset. For example, suppose an asset has a property named REGION. A user can build a pattern for renaming the asset that includes the property name. An example of such a pattern is <REGION><UNDERSCORE><FILE_NAME>. Given this renaming pattern, further suppose that there are two asset versions with the following properties:

Asset A: Name: file1.jpg Region: North America

Asset B: Name: file2.jpg Region: Europe

In the above example, the value “North America” is assigned to Asset A's REGION property, and the value “Europe” is assigned to Asset B's REGION property. Based on the renaming pattern, two files respectively associated with Asset A and Asset B could be renamed from “file1.jpg” and “file2.jpg” to “North America_file1.jpg” and “Europe_file2.jpg”, respectively.

As noted previously, conditions may be placed on the use of digital assets. Based on access control associated with the conditions, if a given user is not authorized to perform a particular action, a corresponding action key may be omitted from a display, while for an authorized user the action key would be shown.

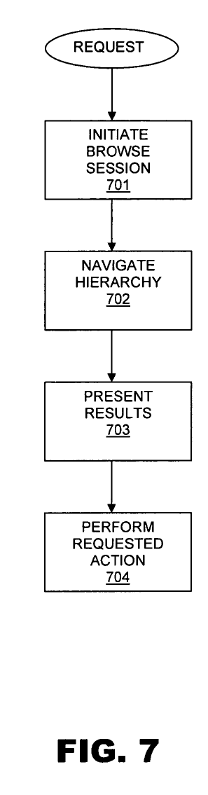

In view of the above, FIG. 7 shows a process flow according to embodiments of the present invention. According to the process, as shown in block 701, in response to a request, the digital asset management application 240 may initiate a browse session. The digital asset management application 240 may determine what actions are available to the user based on the user's authorization, and during the browse session, only present the user those options that are authorized.

Depending on the user's allowed access, the browse session may include navigating a plurality of levels of an asset classification hierarchy, either upward or downward (or backward or forward) or both (block 702). In particular, the navigating may be performed to access a particular digital asset or assets. The digital asset management application 240 may ultimately generate and present a results list of one or more digital assets (block 703).

The digital asset management application 240 may perform a requested action with respect to a selected asset of the results list (block 704). For example, the digital asset management application 240 may (i) cause the asset to be downloaded; (ii) add the asset to a data container (“shopping cart”); (iii) delete the asset; (iv) cause the asset to subscribed to; (v) add the asset to a “favorites” list; (vi) convert an asset to a different file type; or (vii) assign a new filename to an exported asset. The foregoing list is not exhaustive but only exemplary.

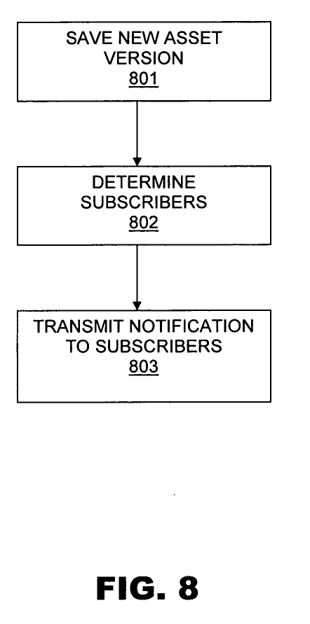

As discussed previously, a user may subscribe to an asset and automatically receive notifications of changes to the asset. For example, the changes may include changes to the properties of a subscribed-to asset, or the addition of a new version of the asset. The subscription may be registered with respect to one or more sub-trees of the hierarchical classification system. In view of the foregoing, FIG. 8 shows an mechanism for the automatic notification. As shown in block 801, a new asset version may be created and saved by the digital asset management application 240. As described above, an asset could belong to multiple sub-trees of the taxonomy. Accordingly, when the new asset version is saved, it may be determined whether there are any subscribers to the sub-trees to which the new asset version belongs, and if so, who the subscribers are (block 802). These subscribers may be automatically notified of the new version, e.g., by e-mail.

One useful application of a digital asset management system as described in the preceding is in connection with marketing campaigns. In such an application, a digital asset or assets could be logically associated with a marketing campaign. For example, the digital asset could be included as an object in a campaign. In this context, “object” means data and an interface comprising functionality to access or modify the data, enabling software associated with the marketing campaign to read and update the object. The object may be updated, for example, to indicate a new use of the asset (e.g., accessing or downloading). This kind of information enables those conducting the campaign to perform useful analyses. For example, the information could be used to judge the success of the campaign (e.g., increased advertising for a product results in increased accesses to a corresponding digital asset). Or, for example, the information could permit quantifying asset values (frequently used digital assets are more valuable than infrequently used digital assets).

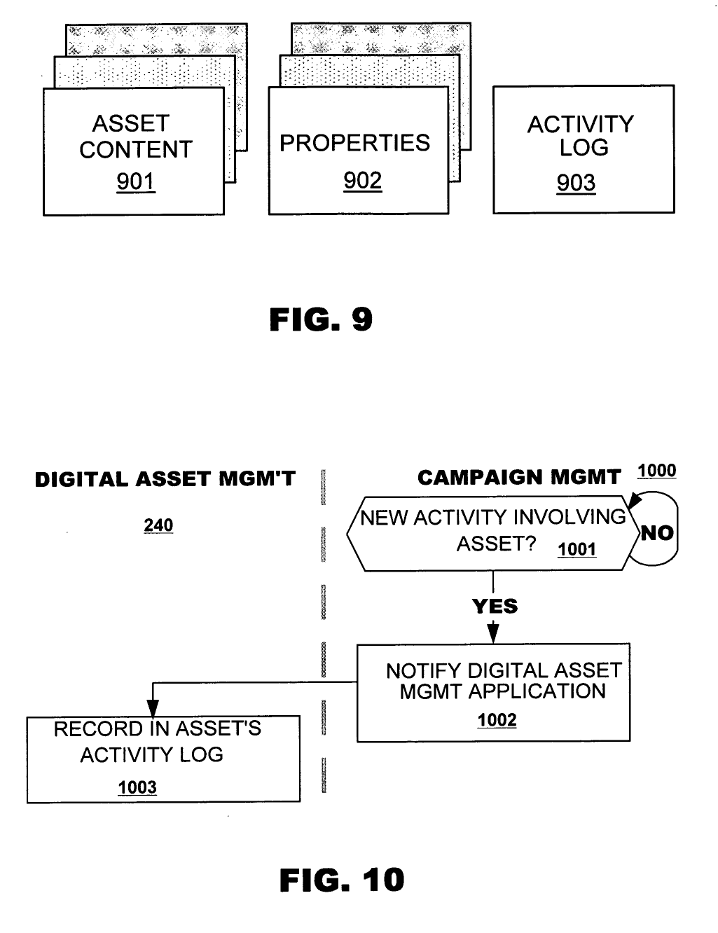

FIG. 9 shows an example of a data model for a digital asset in the above-described application. The asset includes the asset's content 901 and properties 902, which may be replicated if the asset includes multiple versions. The asset further includes an activity log 903 for recording events associated with the asset (e.g., its inclusion in a marketing campaign or use of the asset).

FIG. 10 illustrates a method according to embodiments of the present invention. In the method, a campaign management software application 1000 may monitor activity involving a digital asset (block 1001). If there is activity involving the asset (e.g. a user accesses or downloads the asset), a notification may be sent to the digital asset management application 240 (block 1002). The digital asset management application may record the activity in the asset's activity log (block 1003). As noted previously, the activity information may be used by analytical systems. The activity information may be visible through a digital asset management system portal.

The campaign may, more specifically, involve the creation and use of a campaign object, where “object” has the meaning given above. A linkage may be established between the digital asset object and the campaign object pursuant to the monitoring process described above. It is also possible to create other business objects that could be linked to digital assets along lines described above. Examples include business objects representing products.

As noted earlier, embodiments of the present invention may comprise computer-executable instructions. The computer-executable instructions may be stored and transported on machine-readable media such as magnetic tape, floppy disk or CD-ROM. The computer instructions may be retrieved from the machine-readable media using a suitable reading device into a memory and executed by a processor. The computer-executable instructions may be distributed across a plurality of media, such as on physically separate storage devices respectively associated with physically separate computer systems that may communicate via a network. The functionality disclosed hereinabove for performing the embodiments may find specific implementations in a variety of forms, which are considered to be within the abilities of a programmer of ordinary skill in the art after having reviewed the specification.

Several embodiments of the present invention are specifically illustrated and/or described herein. However, it will be appreciated that modifications and variations of the present invention are covered by the above teachings and within the purview of the appended claims without departing from the spirit and intended scope of the invention.

What is claimed is:

1. A system comprising:
a processor; and
computer-executable instructions for execution by the processor, the instructions to implement a digital asset management application, the digital asset management application to:
in response to a user request, access a database of digital assets, each digital asset including:
one or more versions of the digital asset;
one or more properties classifying the digital asset; and
one or more conditions on use of the digital asset; and
communicate information concerning a digital asset to the user.

2. The system of claim 1, further comprising a network to communicate the information to the user.

3. The system of claim 2, wherein the network is the Internet.

4. The system of claim 1, wherein the conditions relate to legal rights to and/or restrictions on use of the digital asset.

5. The system of claim 1, wherein the digital assets are classified under a hierarchical tree structure.

6. The system of claim 5, wherein the hierarchical tree structure classifies digital assets according to a taxonomy.

7. An automated method comprising:
in response to a request, navigating a digital asset classification hierarchy, each digital asset comprising one or more versions of itself, one or more properties that classify it, and one or more conditions on its use;
based on the navigating, generating a results list including at least one digital asset;
if so, performing a requested action with respect to an asset selected from the results list.

8. The method of claim 7, wherein the action is causing the asset to be downloaded.

9. The method of claim 8, wherein a report is downloaded with the asset, the report including at least a file name and version status of the asset.

10. The method of claim 7, wherein the action is adding the asset to a data container.

11. The method of claim 7, wherein the action is deleting the asset.

12. The method of claim 7, wherein the action is causing the asset to be subscribed to.

13. The method of claim 7, wherein the action converting the asset to a different file type.

14. A machine-readable medium storing computer-executable instructions for performing the method of claim 7.

15. An automated method comprising:
saving a new digital asset version on a digital asset management system;
determining whether the digital asset corresponding to the new asset has any subscribers;
if so, notifying the subscribers of the new version.

16. The method of claim 15, wherein the notification is transmitted via e-mail.

17. An automated method comprising:
associating a digital asset with a marketing campaign;
monitoring activity involving the digital asset; and
if there is activity involving the digital asset, recording the activity in an activity log of the digital asset.

18. The method of claim 17, wherein the activity includes downloading the digital asset.
